(19) United States
(12) Patent Application Publication
(10) Pub. No.: US 2022/0350418 A1
(43) Pub. Date: Nov. 3, 2022

(54) Composite computer keyboard

(71) Applicant: Qiusheng Gao, Newark, CA (US)

(72) Inventor: Qiusheng Gao, NEWARK, CA (US)

(21) Appl. No.: 17/246,748

(22) Filed: May 3, 2021

(51) Int. Cl. G06F 3/02; G06F 3/041; G06F 3/0354; G06F 3/0484; G06F 3/0486; G06K 9/00

(52) U.S. Cl. CPC G06F 3/021; G06F 3/0416; G06F 3/03545; G06F 3/04842; G06F 3/0486; G06K 9/00013; G06F 2203/04106; G06F 2203/04114

(57) ABSTRACT

This invention adds a touch screen to a hardware keyboard as additional input from handwriting for a PC or a laptop. The new keyboard with a small size touch screen provides convenient ways for handwriting notes, drawing graph or painting, converting handwritten characters to formal text. The new keyboard with a large size touch screen can work with a PC/laptop as a PC/laptop with the advantage of input from touch screen over traditional PC/laptop. The new keyboard with a large size touch screen can work with a PC/laptop as a tablet with the advantage of input from hardware keys and mouse over a regular tablet. The new keyboard with a large size touch screen can work with a PC/laptop as a PC/laptop and a tablet simultaneously, either PC/laptop or tablet with the advantage of additional said input ways over a traditional PC/laptop or a tablet. An optional fingerprint sensor provides fingerprint for security application, e.g., account login, document sign and identity verification.

### CROSS REFERENCE TO RELATED APPLICATIONS

I hereby claim benefit of U.S. provisional patent application No. 63/029,563 filed on 25 May 2020 and 63/029,566 filed on 25 May 2020. These two applications are currently pending and hereby incorporated by reference into this application.

### TECHNICAL FIELD

The present invention generally relates to improve the input function of the current computer keyboard, which is used for PC, laptop and tablet. For the existing keyboard, people use key or combined keys to input character by character. A touch screen is added to the new keyboard so people can use handwriting as the input. The touch screen can support digital pen or finger or both as the input tool. An optional fingerprint sensor also could be added to the keyboard for security application, e.g., user log in.

The touch screen can work in three modes. For the first mode, the touch screen catches what is written on the screen. This function is similar to writing a paper note or drawing a graph. For the second mode, the touch screen is used as soft keyboard that can translate handwriting character to formal character. This function is very useful for non-English language. For the third mode, the touch screen is implemented by software as an onscreen keyboard.

When the keyboard has a touch screen for input, the contents of the document can be displayed on the regular screen. In this case, a small size touch screen is good enough, but the user needs the mouse to locate the position of the input and choose font kind of input from the software application. For drawing, erasing or highlighting kind of paper work, it is more convenient to write or draw directly on the file displayed on the touch screen. In this case, a large size touch screen is needed. It works as a tablet and is very efficient for heavy handwriting work.

### BACKGROUND ART

Currently, touch screen technology is developed to a stage that can catch the handwriting input very accurately. New technology is developed to translate handwriting character to formal character. Those new technology help people to input contents to the computer with handwriting instead of key only.

For the formal text in English, it is efficient and comfortable to input the contents with two hands typing the hardware keys and watch the file displayed on the screen with a laptop or PC. For some non-English language, it is more convenient and efficient to use the software to convert the handwriting character to formal text. For handwriting or drawing kind of work, it is more efficient to write on the touch screen sitting flat on the desk with the forearm sitting flat on the desk, but watching a file displayed on the touch screen sitting flat on the desk is not comfortable with the head down for long time. This invention will combine the advantage of the traditional computer/laptop and tablet with multiple ways of input.

The fingerprint technology is also developed to a mature stage. Fingerprint provides more secure and convenient way than signature or regular password for security application.

With the new technology in semiconductor, computer chip becomes cheaper and smaller. Computer can run multiple software application with great performance simultaneously. The new keyboard can make a PC/laptop as a PC/laptop and tablet simultaneously with improved input methodology. User can pre-build and save contents like fingerprint or icons, which are used in the document with high frequency. Then he can output the built-in contents very efficiently with a couple of buttons pressing.

### SUMMARY OF THE INVENTION

1. The object of the present invention is to combine the advantage of key and touch screen input together. A virtual digital pen, eraser and content select rectangle implemented by software are the primary tools for input and editing on the touch screen. An optional fingerprint provides more secure and convenient way for security application.
2. The software application to support the new keyboard needs to be an image file. User can input content to any location of the software user interface. Any point of cursor with a mouse click will be the start point of the new input, whether the input is from the hardware key or handwrite or draw. The last known cursor point will map to the coordinator origin on the touch screen.
3. In accordance with the present invention, a small size touch screen can work in three modes. The contents of the document are displayed on the regular display screen. The user needs to use mouse to choose location, color, line thickness, font type, etc., from the software application. The user can use the regular hardware keys or onscreen softkeys for input.
   3.1 For the first mode, the touch screen catches what is written on the screen. It is named note or N-Mode. To make it easy controlling all activities of writing, erasing, etc., a soft digital pen with a pen icon is implemented by software. The user needs to use a digital pen or a finger to press at said pen icon before writing. The touch screen will catch the touch press at each point and interpret the continuous movement of the digital pen or finger between two points as a line or curve until the touch press is released. User can write or draw something in the area already displaying some contents, it will overwrite the data for each point touched. The touch screen driver will free the memory, if not shared with the software application, and clear the display on touch screen (4) if the user presses the clear button, click the mouse on the software application, or the current active program displayed on the regular screen (9) or (10) is switched to another software application. Each continuous line or curve will be split to a set of point with the coordinator (x, y). The input will be transformed to a set of data with coordinator (x, y) for a single point and/or continuous points for a straight line or a curve. The data could be stored with xml or html or other similar format with tags, e.g., point and line. This function is similar to writing a paper note or drawing a graph. Here is a sample of data format.
      <input>
      <origin>x0, y0</origin>
      <point>x1, y1</point>
      <line>x2, y2, x3, y3</line>
      <curve>x4, y4, x5, y5, x6, y6, x7, y7</curve>
      </input>
   3.2 For the first mode, the data for points or lines are coordinator (x, y) relative to an origin point that is the intersection of the line at left and top in the user interface that has icons for a digital pen and an eraser. After the user presses the pen icon, he can handwrite or draw on the touch screen. The touch screen driver will send the transformed data to one or separate message queue accessed by the software application and touch screen driver for display. The display on the touch screen should appear before the display in the software application. The contents input from the touch screen are displayed on the software application, starting from the flashing cursor that maps to the coordinator origin on the touch screen.
   3.3 For the first mode, if user writes something wrongly, he can erase part of what is displayed on the touch screen. A soft eraser is implemented with a small size of square. The user presses the eraser icon with a digital pen or finger. The erasing area is the square size of the eraser with the touch pressing point as the center of the square, either a single touch press or continuous touch movement. The erased contents will be displayed as empty space without points being touched. The data of erasing size and location will be sent to the message queue. The touch screen driver for display will clear the display for erased area and update the data. The software application will clear the same display size of area touched by the eraser with the cursor coordinator mapping to the coordinator origin on the touch screen, and update the data.
   3.4 For the first mode, a soft contents selection tool with a rectangle icon is implemented with an adjustable rectangle. A user can choose rectangle area of contents for editing, using a digital pen or a finger, after pressing the rectangle icon, drawing a diagnose line of the rectangle. The size of the rectangle is decided by the starting point as top left and releasing point as bottom right. The four sides of the rectangle are displayed after the touch pressing press is released. If the user wants to edit the contents currently displayed on the touch screen, he can choose the editing area then drag the display location by a digital pen or a finger, or adjust the display size by finger pinch. If the user wants to edit the contents already entered, he should press a soft edit button first. Then a new interface, with icons of a pen, eraser and rectangle, are displayed on the touch screen. The user needs a mouse click at the software user interface first, then pressing at the rectangle icon then drawing a diagnose line on the touch screen, a rectangle size on the touch screen is decided by the starting and ending pressing point as the top left and bottom right. The editing area has the same size of said rectangle and the location is decided with the cursor on the regular screen mapping to the coordinator origin on the touch screen. Four sides of the rectangle for editing area are displayed on the software application and the touch screen. The software application will send the selected contents to the touch screen driver for display, and the contents of selected area are also displayed on the touch screen. The display location can be adjusted on touch screen by dragging with a digital pen or a finger, or with more accuracy by location adjust keys of soft up key, down key, left key and right key for selected contents. The display size can be adjusted by finger pinch, or with more accuracy by soft up arrow and down arrow to increase or decrease the scale ratio. The user interface is shown in 9, but not limited to FIG. 9. The user also can input some new contents after pressing the pen icon, or erase some contents after pressing the eraser icon then moving the eraser with the digital pen or finger. If the selected contents are moved to a new location, it will overwrite the original contents displayed in this area. When each action, e.g., dragging, pressing the soft adjust key, etc., is done, the touch screen driver will send the transformed data to the software application, which will update the data and display, and send the updated data to the touch screen driver for display. It would be more efficient that the software application shares the memory with the touch screen driver for display, for the selected contents. After the user finishes editing, he presses the finish button. Then the user interface switches back to the interface for input, and the adjusted contents of the software application is displayed on the regular screen. During the editing process, if there is event, e.g., mouse click on the same active software application, the touch screen driver will switch back to the previous user interface.
   3.5 For the second mode, the touch screen can convert what is handwritten or drawn to formal text. It is named convert or C-Mode. The touch screen drive software will instantly interpret the touch press or movement to the target object, e.g., a list of Chinese character or word, which is displayed on the touch screen immediately. The user chooses the correct object by touching that object. The data will be stored as Unicode. This function is very useful for non-English language.
   3.6 For the third mode, the touch screen can provide pre-built contents or onscreen keyboards with proper user interface. User also can build contents, e.g., fingerprint or icons under third mode. It is named build-in mode or B-Mode.
   3.7 There is a soft button to switch between three modes. The soft button starting as note mode with N-Mode displaying at the button. Pressing the button will switch to convert mode with C-Mode displaying at the button. Pressing the button will switch to build mode with B-Mode displaying at the button. Pressing the button again will switch back to note mode or N-Mode.
4. The contents from the touch screen could be a single character, one line or multiple lines of character, a curve or a graph, etc. If the touch screen is full of display, user presses a clear button to clear the display on the touch screen. Touch screen driver for display will free the temporary storage, or update the memory address if it shares the data with the software application.
5. Said edit, clear and finish button could be implemented as software or hardware button, preferring software. In the documents of this invention, the software button is used.
6. For drawing, erasing or highlighting with different color kind of paper work, it is more convenient to display the software application on the touch screen directly so the user can use the digital pen or finger for writing, drawing, locating the position, choosing color, line thickness, font type, etc. In this case, a large size touch screen is needed to display the contents of the software application.
7. The large size touch screen can work in three modes: PC/laptop mode, tablet mode and PC/tablet simultaneous mode. The operating system should provide the APIs for software application to use the interfaces for touch screen as onscreen touch screen and build the function of pen, eraser, edit area selection rectangle., etc., on the software application and its user interface.
   7.1 For the first mode, the large size touch screen works with a PC/laptop that supports the new keyboard as a PC/laptop. In PC/laptop mode, the software application is opened on the regular screen. The software application can call the system API to get the onscreen touch screen with the same functionality and user interfaces of the small size touch screen, but the user interfaces for the onscreen touch screen displayed on the large size touch screen could have a larger user interface than the touch screen of small size has.
   7.2 For the second mode, the large size touch screen works with a PC/laptop that supports said new keyboard as a tablet. In this mode, all file icons displayed on the regular screen will also be displayed on the touch screen. Pressing the file icon on said touch screen will lunch the software application that is displayed on the touch screen. A user can write or draw or edit on the software application directly on the touch screen with said icons of pen, eraser, rectangle, etc., which is implemented and displayed on the user interface of the software application. The software application can also use the onscreen touch screen provided by the system with the same functionality of the small size touch screen. Under tablet mode, user can also use the hardware keyboard, onscreen keyboard and mouse as input.
   7.3 When two different software applications are lunched on the regular screen and touch screen with large size at the same time, the software application opened on the regular screen can use the onscreen touch screen, hardware keys and mouse as input device, and the software application opened on the tablet can use the input from hardware keys, mouse, or directly from the touch screen.
   7.4 For the third mode, one software application is lunched on the regular screen and the same software application is lunched on touch screen with large size at the same time. The software application opened on the regular screen will work at said PC/laptop mode described in 6.1, the software application opened on the touch screen will work at tablet mode described in 6.2. It provides the best user experience with input from hardware keys and mouse to the file displayed on the regular screen and handwriting input directly from touch screen to the file displayed on the touch screen. The operating system needs to synchronize the output and input for the software application on said two screens. The input data needs to be displayed on both screen before next input. The software application also needs to support the new input technology.
8. The touch screen could be designed as a slidable part attached to the bottom of the keyboard so the user would be more comfortable to carry the keyboard and write on the screen. When the touch screen is moved out, it trigs a trigger power switch and turn on the power for the touch screen. When the touch screen is moved in, the power for the screen is turned off after it trigs the trigger power switch. There are many ways to design a trigger power switch and this invention will not go further for the details of a trigger power switch.
9. In accordance with the present invention, an optional fingerprint sensor can provide more secure and convenient way for security application.
10. In accordance with the present invention, it is needed to modify the input/output, GPU, operating system and software application, etc., to support the function of the new keyboard.

### BRIEF DESCRIPTION OF THE DRAWINGS

FIG. 1 provides the primary vertical view from the top when the new keyboard is put on the desk. A small size touch screen is put at the right bottom corner of the keyboard.

FIG. 2 provides the primary vertical view from the top when the new keyboard is put on the desk. A large size touch screen is put at the right part of the keyboard.

FIG. 3 provides the primary vertical view from the top when the new keyboard is put on the desk. A slidable touch screen with large size is pulled out at the right part of the keyboard.

FIG. 4 provides a 3-D view of a laptop with the new keyboard. A mouse and a digital pen are sitting beside the laptop.

FIG. 5 provides a 3-D view of a PC with a regular display screen and a new keyboard. A mouse and a digital pen are sitting beside the new keyboard. There are cables connecting the new keyboard with the PC, but the new keyboard can be connected to the PC by wireless connection. To make the new keyboard compatible with the regular PC, the components for mouse pad and hardware keys are not changed with a separate cable connecting the hardware keys and mouse pad to the PC.

FIG. 6 provides the mode transition between note mode, convert mode and built-in mode of the small size touch screen.

FIG. 7 provides the initial user interface for a small size touch screen. Lines with size indicator guides the area for writing and drawing. The user can use a digital pen or a finger to write or draw inside the rectangle. Pressing the N-Mode button, the user interface will switch to the UI for convert mode or C-Mode in FIG. 8. Pressing edit button can choose the editing area on the software application for editing. Pressing the clear button will clear the buffer and display on the touch screen.

FIG. 8 provides the user interface for a small size touch screen under convert mode or C-Mode. Lines guides the rectangle area for writing or drawing. Pressing the lang button, a list of language is displayed on the touch screen. User can choose one language by pressing the displayed item. Then user can handwrite on the touch screen. What is written is instantaneously displayed on the touch screen and interpreted by the driver software to a few possible formal texts, which are displayed on top of the touch screen. User can choose the correct text by pressing it or delete it using the virtual eraser. Pressing the clear button will clear the display on the touch screen. Pressing the C-Mode button will switch to B-Mode.

FIG. 9 provides the user interface for editing contents of software application with a small size touch screen under note mode, or N-Mode. User can choose the editing area using a digital pen or finger to draw a diagnose line that decides the top left point and bottom right point of the rectangle. The location of the chosen area is based on the cursor coordinator mapping to the coordinator origin on the touch screen. The contents chosen area on software application are also displayed on the touch screen. There are soft keys to move the contents up, down, left or right. The display size can be changed by a scale ratio that is controlled by a soft up arrow and down arrow to increase or decrease its value. Contents can be added or removed in the selected area using a digital pen or a finger after pressing the virtual pen or eraser icon.

FIG. 10 provides the user interface for a small size touch screen under build-in mode or B-Mode. Pressing the sign button, a list of signatures will be displayed on the touch screen. Pressing on the object, the selected signature will be output to the software application. Pressing the finger button, a list of fingerprints will be displayed on the touch screen. Pressing on the object, selected fingerprint will be output to the software application. Pressing on the icons button, a list of pre-built icons is displayed on the touch screen. Pressing on the object, selected icon will be output to the software application. Pressing the build button will switch to interface in FIG. 11, 12 or 13, depending on the item selected by the user.

FIG. 11 provides the user interface for a small size touch screen to build signatures. After user presses the build button in user interface in FIG. 10, several items are displayed on the touch screen. By choosing the signature item, touch screen displays user interface in FIG. 11. User uses a digital pen (13) to sign on the touch screen. Then he presses the soft save button to save the signature, or pressing the soft clear button to clear the buffer and sign again. A list of signatures is displayed on the touch screen when soft sign button is pressed. Pressing one signature then pressing clear button will delete this saved signature. Pressing the B-Mode button, the user interface will switch back to that in FIG. 10.

FIG. 12 provides the user interface for a small size touch screen to build fingerprint. After user presses the build button in user interface in FIG. 10, several items are displayed on the touch screen. By choosing the fingerprint item, touch screen displays user interface in FIG. 12 with remind text for user to put the right thumb on the fingerprint sensor. User puts his right thumb on the fingerprint sensor. After a while, a ready text with the fingerprint is displayed on the touch screen. Then he presses the soft save button to save the fingerprint, or pressing the soft clear button to clear the buffer and try again. A list of fingerprints is displayed on the touch screen when soft finger button is pressed. Pressing one fingerprint then pressing clear button will delete this saved signature. Pressing the B-Mode button, the user interface will switch back to UI in FIG. 10.

FIG. 13 provides partial user interface for a small size touch screen to build icons. After user presses the build button in user interface in FIG. 10, several items are displayed on the touch screen. There should be more button for color or line thickness, etc., this invention will not go further. By choosing the icons item, touch screen displays user interface in FIG. 13. User uses a digital pen (13) to draw an icon on the touch screen. Then he presses the soft save button to save the icon, or pressing the soft clear button to clear the buffer and draw again. A list of icons is displayed on the touch screen when soft icons button is pressed. Pressing one icon then pressing clear button will delete this saved icon. Pressing the B-Mode button, the user interface will switch back to that in FIG. 10.

Following are the detailed information about the primary components of the new keyboard.

1. A new keyboard with hardware keys, a mouse pad, a small size or a slidable touch screen and an optional fingerprint sensor.

2. Hardware keys, same as those on the regular hardware keyboard. Attached figures only show a few keys. The regular keyboard has an area with duplicated keys. The new keyboard prefers removing those duplicated keys when a big size touch screen is put on the right part of the keyboard.

3. A mouse pad same as that on the regular hardware keyboard.

4. A touch screen with small size. This screen is built at the right bottom corner of the new keyboard. This screen could be built at other part of the new keyboard.

5. A new fingerprint sensor. It is optional.

6. A touch screen with large size. This screen is built on right part of the keyboard. All file icons appeared on the regular screen are also displayed on this large size screen. Pressing the icon will lunch the software application. User can use touch screen, hardware keyboard and mouse as input for the software application opened on this large size touch screen.

7. An onscreen touch screen displayed on the large size touch screen. The function of this onscreen touch screen is similar to function of said small size touch screen. User can use this onscreen touch screen as input for the current active software application opened either on the regular screen or on the large size touch screen.

8. A slidable touch screen with large size. This touch screen is attached at the bottom of the hardware keyboard. When the touch screen is moved out, it trigs a power trigger switch and the power for the touch screen is turned on. When the touch screen is moved in, the power for the screen is turned off after it trigs a power trigger switch.

9. A regular display screen on the laptop.

10. A hardware mouse.

11. A laptop with a new keyboard.

12. A regular display screen for PC.

13. A digital pen for the touch screen.

14. A PC that supports the new keyboard.

15. File icons displayed on the regular screen for PC or laptop. Those icons are also being displayed on the touch screen with large size.

16. Cables connecting between PC, mouse and keyboard. To make the new keyboard compatible with the traditional PC, the components related to the hardware keys and mouse pad are not changed. The touch screen connects with the PC using a separate cable.

17. Lines with measurement indicator for the coordinator location.

18. Area for writing and drawing.

19. A soft button with N-Mode displayed at the surface, showing the touch screen being under N-Mode. Pressing this button will switch to C-Mode.

20. A soft clear button. Pressing this button, the touch screen driver software will clear the screen display. In the user interface in FIGS. 11, 12 and 13, pressing the clear button will delete the selected saved contents.

21. A soft button with C-Mode displayed at the surface, showing the touch screen being under C-Mode or convert mode. Pressing this button will switch to B-Mode.

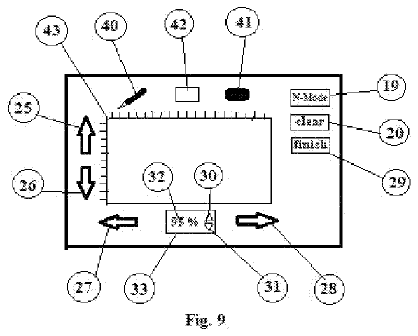

22. A soft edit button. Pressing this button, the user interface will switch to FIG. 9 for contents editing.

23. A soft language key. Pressing this key will switch between different language.

24. Line indicating the coordinator location for writing area.

25. A soft up key. Pressing this key will move display of contents in selected area up on the software application.

26. A soft down key. Pressing this key will move display of contents in selected area down on the software application.

27. A soft left key. Pressing this key will move display of contents in selected area left on the software application.

28. A soft right key. Pressing this key will move display of contents in selected area right on the software application.

29. A soft finish button. Pressing this button will end the contents editing, and the touch screen driver software will switch the user interface to FIG. 7 for input.

30. A soft up arrow. Pressing this arrow will increase the scale ratio of the display in selected area on software application.

31. A soft down arrow. Pressing this arrow will decrease the scale ratio of the display in selected area on software application.

32. The value of scale ratio. This value of ratio is calculated as the new display size of selected contents on the software application divided by the original display size.

33. A text box that controls the display size of selected contents on software application.

34. A soft button with B-Mode displayed at the button surface, showing the touch screen being under build mode. Pressing this button will switch to N-Mode.

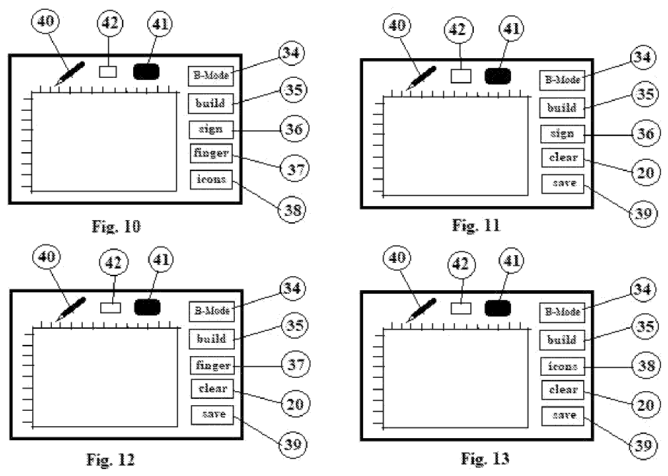

35. A soft build button. Pressing this button will display a list of items to be built, e.g., icons, signature, etc. Pressing the signature item will go to interface in FIG. 11. Pressing the fingerprint item will go to interface in FIG. 12. Pressing the icons item will go to interface in FIG. 13.

36. A soft sign button. In the user interface in FIGS. 10 and 11, pressing this button will provides a list of signatures. In the user interface in FIG. 10, pressing the displayed signature will output it to the software application. In the user interface in FIG. 11, pressing the selected signature than pressing the clear button will delete this signature.

37. A soft fingerprint button. In the user interface in FIGS. 10 and 11, pressing this button will provide a list of fingerprints. In the user interface in FIG. 10, the selected fingerprint will be output to the software application by pressing at that fingerprint. In the user interface in FIG. 11, the selected fingerprint will be deleted after pressing at the displayed fingerprint then pressing clear button.

38. A soft icons button. In the user interface in FIGS. 10 and 11, pressing this button will provide a list of icons. In the user interface in FIG. 10, the selected icon will be output to the software application by pressing at that icon. In the user interface in FIG. 11, the selected icon will be deleted after pressing at the displayed icon then pressing clear button.

39. A soft save button. Pressing this button will save the contents displayed on the touch screen.

40. A soft pen icon. User can handwrite or draw on the touch screen after pressing this icon with a digital pen or a finger.

41. A soft eraser icon with a small size of square. When the contents of software application are also displayed on the touch screen, user can delete square size of the eraser for contents displayed on the software application by a digital pen or a finger after pressing the erase icon. The touch pressing point is the center of the square. The display of deleted contents are also cleared on both touch screen and software application on regular screen.

42. A soft rectangle icon. User can draw a rectangle by drawing a diagnose line of the rectangle on the touch screen with a digital pen or a finger after pressing at the rectangle icon in the user interface 9. The editing area on the software application has the same size of the rectangle on the touch screen with the cursor coordinator mapping to the coordinator origin of the touch screen.

43. A coordinator origin on the touch screen. It is the cross point of the left line and top line on the touch screen.

44. A new keyboard with a touch screen of large size.

### DETAILED DESCRIPTION OF PREFERRED EMBODIMENTS

When a laptop (11) or a PC (14) is powered on, the user can put the right thumb at the fingerprint sensor (5) to log in.

For first mode with a small size touch screen (4), the best way is to write a note with lots of formal text input and some light work for handwriting and drawing. User A tries to create a note with a word or PDF kind of software application that supports the handwriting input. After the note software application is started, user A types a few lines of formal text on the software application with hardware keys (2). Then he starts handwriting on the touch screen (4) in user interface shown in FIG. 7, with a digital pen (13) or a finger. Then he draws a few curves. The contents entered are instantaneously displayed on said touch screen (4) and in the software application on the regular screen (9) or (12). He presses the virtual eraser icon (41) to remove a few wrong contents that are still displayed on the touch screen (4). Some removed contents are in middle of the touch screen, then he selects right part of the display after touch press the rectangle icon (42), dragging the selected area to left with a finger. The touch screen (4) is almost full of display, he presses the soft clear button (20) and the touch screen driver clears display on the touch screen (4). User A feels that the display of some contents in software application on the regular screen (8) or (12) need to be adjusted. He presses the soft edit button (22) and it switches to the user interface in FIG. 9. First, he presses the rectangle icon (42) on top of the touch screen with a digital pen (13). Then he draws a diagnose line that decides the size of a rectangle on the touch screen (4). The same size of rectangle is selected in the software application displayed on the regular screen (9) or (12). The location of the rectangle is based on the cursor coordinator mapping to the coordinator origin on the touch screen. After the contents are selected in the software application, the selected contents are also displayed on the touch screen (4). Then he can adjust the size of the display for selected contents by finger pinch or by pressing the soft up arrow (30) or down arrow (31) with more accuracy, and adjust location of the display for selected contents by dragging or by pressing the soft up key (25), down key (26), left key (27) and right key (28) with more accuracy. He can add new contents by writing with a digital pen (13) or a finger after pressing the pen icon (40) and removing contents by a digital pen (13), or remove contents by a finger after pressing the eraser icon (41) on the touch screen (4). After he finishes editing, he presses the finish button (29) then the user interface switches back to FIG. 7 for input. User A wants the handwritten part with blue color, then he uses the mouse (10) moving the cursor to the color icons at the top of the note application and chooses the blue color. He starts handwriting again and the contents are displayed with blue color. Finally, he finishes the note, sign it with a signature.

For second mode with a small size touch screen (4), the most efficient way is typing a document for non-English character. User B is a Chinese. He is typing a letter with Chinese character, but he does not like using Pingyin to input the Chinese character. First, he opens the word on the regular screen (9) by clicking the word icon (15) with a mouse (10). He then presses the soft N-Mode (19) and the touch screen (4) displays a new interface with a soft button C-Mode and lang. User B then presses the soft lang button and chooses the Chinese language. He starts writing Chinese character with a digital pen (13) and it is translated to a list of possible formal Chinese character displayed on top of the touch screen (4). He pressed the correct Chinese character and the data in Unicode is sent to the word application. This letter also needs to be translated to English right after the Chinese character. After he finishes the input for Chinses character, he uses the hardware keys (2) to input the English part. After he finishes all inputs, he needs to sign a signature. He presses the soft C-Mode button (19) and it switches to B-Mode button (34). He presses the sign button (36) and a list of saved signatures appears on the touch screen (4). He chooses one of them by pressing this signature.

For third mode with a small size touch screen (4), the most efficient way is to input built-in contents, e.g., fingerprint or signature. User C presses the N-Mode (19) button twice and it appears as B-Mode (34) at user interface in FIG. 10. He presses the build button (35), a list of items appears and he selects fingerprint item. A new interface in FIG. 12 appears with a text “put your thumb at top of fingerprint sensor”. After he puts the thumb at the fingerprint sensor (5) for a while, a fingerprint appears at the touch screen (4) and a text of “ready”. Pressing the save button will save the fingerprint and go back to previous user interface. Pressing the clear button will start over for fingerprint input. User C presses the build button (35) at user interface in FIG. 10, a list of items appears and he selects icon item. The touch screen (4) displays a new user interface in FIG. 12. There is a button with text “import from file”. Pressing this button, user can import an image file. After the image is displayed on the touch screen (4), user can save it by pressing the save button. He also can draw an icon on touch screen (4) and save it by pressing the save button (39). After the icon is saved, the user interface on touch screen switches back to the previous user interface.

For a large size touch screen (6) working at tablet mode, it is more efficient for drawing graph or painting or heavy handwriting work. User D is designing a component for a car. He has a new keyboard (1) with a slidable large size touch screen (8) attached to the bottom of the keyboard (1). First, he pulled the touch screen (8) out and the power for the touch screen (8) is turned on after it trigs a power switch. The touch screen (8) starts with all file icons displayed. He then presses the icon for the painting software with a finger on said large size touch screen (8). The painting software is started and a blank field is displayed on said slidable touch screen (8), with pen icon (40), eraser icon (41) and rectangle icon (42) on top of the user interface for the painting software. User D uses the hardware keys (2) to input the name of the car component at the top of the blank field. Then he starts drawing with a digital pen (13) directly on the screen (8). He can use the digital pen (13) or the mouse (10) to choose the color or the thickness of the line at the interface of the painting software. He can remove the contents by the virtual eraser (41), or drag the selected contents by a virtual rectangle (42), on the painting software user interface directly. After he finishes the design graph, he saves the document. Then he pushed the slidable touch screen (8) into the keyboard and the power for the touch screen (8) is turned off.

For a large size touch screen (6) working at PC/laptop mode, an onscreen touch screen (7) that includes the same functionality as said small size touch screen (4) has, is displayed on said touch screen (6) or (8). It is more efficient for document with lots of input for formal text input and some light handwriting and drawing work. User E is working for a document with Chinese character. He opens a word application by clicking the word icon (15) on the regular display screen (12). The onscreen touch screen on said touch screen (6) or (8) is popped up. He then uses hardware keys (2) to input the Chinese character using Pingyin, but he could not find some Chinese character by Pingyin. User E presses the N-Mode soft button (19) on the onscreen touchscreen (7) and it switches to convert mode or C-Mode. He then writes the Chinese character with a digital pen (13) on the onscreen touch screen (7) and a list of Chinese character displayed at top of the onscreen touch screen (7). User E finds the correct Chinese character and selects it by pressing that character using the digital pen (13). The touch screen driver sends this character as Unicode to the word application. Then user E needs to draw a simple graph in the document. He presses the C-Mode soft button and it switches to B-Mode. He presses B-Mode button and it switches back to N-Mode. Onscreen touch screen (7) displays an interface same as FIG. 7 shows. Then he draws a few lines and curves on area (18). Next input are a few curves with red color. User E chooses the red color by clicking the red color at the word interface with a mouse. Then he draws the curves on the onscreen touch screen. The curves are displayed with red color in the painting software.

For a large size touch screen (6) or (8) working at PC/laptop mode and tablet mode simultaneously, the best practice is for a student reading a book on the regular screen (6) or (8) and writing notes on the touch screen (4). Student D opens a book on the regular screen (6) with a reading software, which allows him to write comments on the book. At same time he needs to write notes for the class. He opens a PDF kind of software on the touch screen (4). He needs to write some comments on the book, then he uses the mouse to move the cursor to some empty space. The book software will call the system APIs to pop up the onscreen touch screen (7). He presses a digital pen (3) at the color icon and chooses the yellow color. Then he writes some comments on the onscreen touch screen (7). The touch screen driver sends the comments to the book software, which displays the comments with yellow color at the empty space near the last cursor point on the book interface. During the class, he needs to write notes on touch screen (6). After he touches the note interface with a digital pen (13), the onscreen touch screen (7) disappears. He can use the digital pen (13) for handwriting or drawing figures. He also can use the virtual eraser (41) to erase some contents, or drag the selected contents around.

For the best user experience and input efficiency of the new keyboard, one document is opened on the regular screen (9) or (12) and the same document is opened on touch screen (6) or (8). Two processes use the same data in shared memory. User E clicks the document interface on the regular screen (12) and starts typing text with the hardware keys (2). The entered contents are displayed on both the regular screen (12) and the touch screen (8). Then he needs to draw a graph on the document. He presses the pen icon (40) in the document interface and starts drawing a triangle with a ruler. Then he finds icons of line, curve, circle, etc. He presses the circle with the digital pen and draws a circle pretty fast. He switches back and forth between the regular screen (12) and the touch screen (8) and feel very comfortable to input text and draw graph in the document.

### VARIATIONS OF THE INNOVATION

There are many types of variation of this innovation. Here are a few examples.

The touch screen can be designed as a detachable part.

The touch screen should be on the left side of the keyboard for left-handed user.

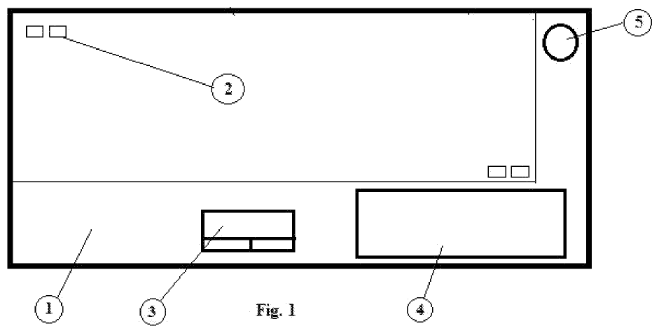

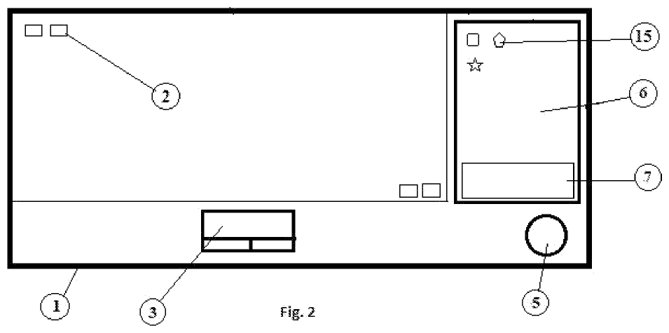

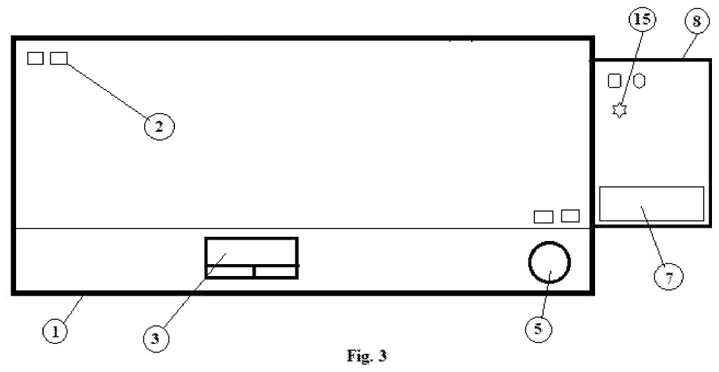

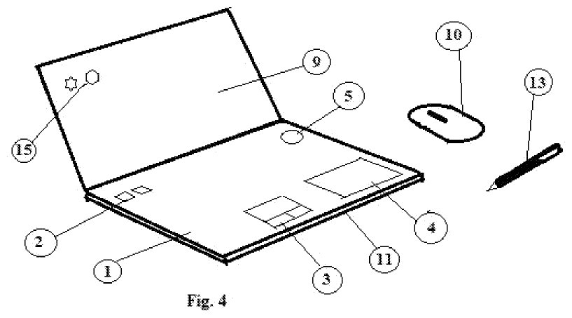

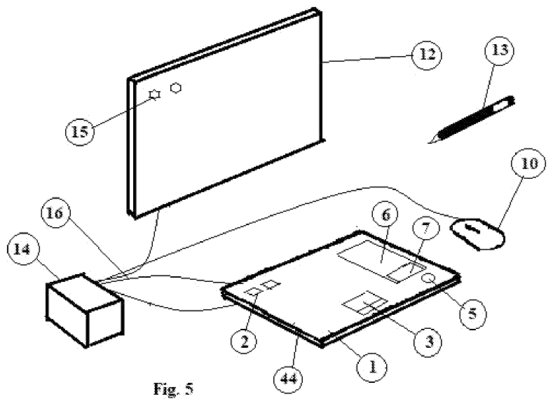

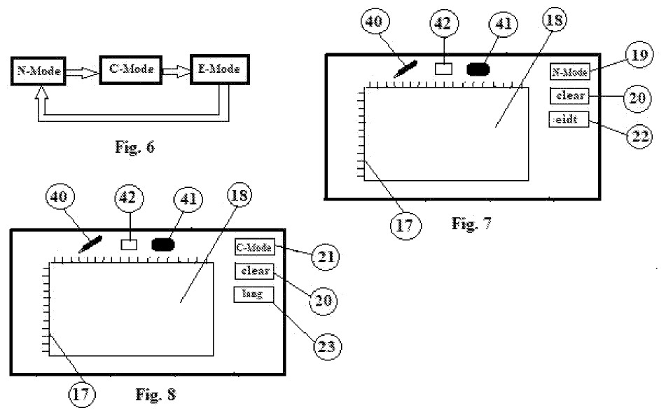

The layout of the touch screen or fingerprint can be different from FIG. 1 or FIG. 2.

The layout of the touchscreen (4) user interface can be different from FIG. 7.

1: A new computer keyboard (1) comprising:
hardware keys (2) that are same as the regular hardware keyboard has,
a mouse pad (3) that is same as the regular hardware keyboard has,
a touch screen (4) with small size as a new input device with its driver software and storage,
a new optional fingerprint sensor (5) with its driver software and storage,
said new keyboard (1) has the layout shown in FIG. 1 but not limited to this layout,
said hardware keys (2) or mouse pad (3), or touch screen (4) with a digital pen (13) or a finger, can be used as the input device for software application displayed on the regular screen (9) or (12).

2. Said new keyboard (1) of claim 1, wherein said touch screen (4) and its driver software can catch what is written or drawn on said screen (4) by a digital pen (13) or a finger after pressing at the pen icon (40) in the user interface (7), with a single touch press as a point and continuous movement of touch press as a line or curve, and entered data at the point newly pressed will overwrite the stored data for the same point, and the entered contents are displayed on said touch screen (4) and in the software application on the regular screen (9) or (12) when the touch screen driver for display and software application receives the data sent from touch screen driver for sensors.

3. Said new keyboard (1) of claims 1, 2, wherein said touch screen (4) and its driver software can be used to input data for software application by a digital pen (13) or a finger, the display for newly entered contents on software application are same as what displayed on the touch screen (4), the display location is based on the cursor point last clicked on regular screen (9) or (12) mapping to the coordinator origin (43).

4. Said new keyboard (1) of claims 1, 2, 3, wherein said touch screen (4) and its driver software will clear display currently still on the touch screen (4) with square size of eraser (41), which is implemented as a square with small size and the pressing point as center and all points inside the square are updated as not touched once a digital pen (3) or a finger pressed the eraser icon (41) then pressed any point or move around on the touch screen (4) in user interface (7), after a user presses at one point or move around on said touch screen (4) by a digital pen (3) or a finger that has touched said eraser icon (41), and the software application will clear the display of same size of the erased area with the cursor point last clicked mapping to the coordinator origin (43), and the data for erased area will be updated as every point not touched on both touch screen (4) and regular screen (9) or (12).

5. Said new keyboard (1) of claims 1, 2, 3, 4, wherein said touch screen (4) and its driver software will clear the display on the touch screen (4) and free its memory, if not shared with the software application, with event of pressing the soft clear button (20) in the user interface (7), or event of clicking the mouse on the software application, or event of switching the current active program to another software application, but the software application will not clear or update anything unless the contents currently displayed on the touch screen (4) are not displayed on regular screen (9) or (12).

6. Said new keyboard (1) of claims 1, 2, 3, 4, 5 is very efficient and convenient for handwriting notes, drawing graph or paintings, and especially useful for a real handwriting signature, comparing with the digital signature or handwriting signature input by a mouse.

7. Said new keyboard of claims 1, 2, 3, 4, 5, 6, wherein said touch screen (4) and its driver software could convert the input to a set of data for software application with coordinator (x, y) for point, line and curve in the format of xml or html or similar type with the following sample of data in xml format.
<input>
<point>x1, y1</point>
<line>x2, y2, x3, y3</line>
<curve>x4, y4, x5, y5, x6, y6, x7, y7</curve>
</input>

8. Said new keyboard (1) of claims 1, 2, 3, 4, 5, 6, 7, wherein said touch screen (4) and its driver software can be used as the input to adjust the display location and update the contents of the software application, choosing the editing area on the software application with the same size of a rectangle by drawing a diagnose line of said rectangle using a digital pen (13) or a finger after pressing at the rectangle icon (42) on touch screen (4), which is implemented as an adjustable rectangle with the pressing point as the center and size decided by a diagnose line with starting point as top left and touch releasing point as bottom right, with the cursor last clicked on the regular screen (9) or (12) mapping to the coordinator origin (43) on said touch screen (4), and the side lines of the rectangle are displayed on both touch screen (4) and regular screen (9) or (12), and the contents of selected area on software application being displayed on the touch screen (4).

9. Said new keyboard (1) of claim 8, wherein said touch screen (4) can be used as the input to adjust display location of said selected editing rectangle area of the software application on regular screen (9) or (12) by dragging with a digital pen (40) or a finger, or by pressing soft up key (25), soft down key (26), soft left key (27), soft right key (28) with more accuracy, and adjust the display size by finger pinch or by the scale ratio (32) with more accuracy by pressing soft up arrow (30) or down arrow (31) to increase or decrease the scale ratio value that is calculated as the new display size on the software application divided by the original display size, with the contents of the selected area overwriting the contents of area moved in.

10. Said new keyboard (1) of claims 1, 2, 3, 4, 5, 6, 7, 8 and 9, wherein said touch screen (4) and its driver software can be used as input to update the contents of selected rectangle area of the software application with the new entered contents using a digital pen (13) or a finger after pressing the pen icon (40) or clear part of the display with data of no touch point in the erased area using a digital pen (13) or a finger after pressing the eraser icon (41).

11. Said new keyboard (1) of claims 1, 2, 3, 4, 5, 6, 7, 8 and 9, wherein said touch screen (4) and its driver software can convert what is written on the touch screen (4) to the formal text based on the order and length of the touch path, which is especially efficient for non-English character that are stored with Unicode.

12. Said new keyboard (1) of claim 1, wherein said touch screen (4), its driver software with user interface in FIG. 11, FIG. 12 and FIG. 13 can build, save and delete complicated contents, e.g., signature, fingerprint, icons, which can be output to the software application in the user interface in FIG. 10, with detailed steps in the specification.

13. A new computer keyboard (44) comprising:
hardware keys (2) that are same as the regular hardware keyboard has,
a mouse pad (3) that is same as the regular hardware keyboard has,
a touch screen (6) of large size as a new input device with its driver software and storage,
a new optional fingerprint sensor (5) with its driver software and storage,
said new keyboard (44) has the layout shown in FIG. 5 but not limited to this layout,
said hardware keys (2) or mouse pad (3) or touch screen (6) with a digital pen (13)/a finger can be used as the input device for software application displayed on the regular screen (9) or (12), or on the touch screen (6),
all file icons (15) displayed on the regular screen (9) or (12) are displayed on the touch screen (6), and the software application opened on the touch screen (6) by pressing at that file icon are also displayed on the touch screen (6) of large size.

14. Said new keyboard (44) of claim 13, wherein an onscreen touch screen (7) that has same functionality and interfaces of said touch screen (4) in claims 1, 2, 3, 4, 5, 6, 7, 8, 9, 10, 11, 12, can be displayed on large size touch screen (6) by system API calls on the software application, and used as input for the software application displayed either on said large size touch screen (6) or said regular screen (9) or (12).

15. Said new keyboard (44) of claims 13, 14, wherein said large size touch screen (6) can work with a PC (14) or laptop (11) as a Tablet with input from said onscreen touch screen (7) or directly from said large touch screen (6) with icons of pen (40), eraser (41) and other editing tools embedded with the user interface for the software application using a digital pen (13) or a finger, with additional way for input from hardware keys (2), or mouse (10) and mouse pad (3), having the advantage over a regular tablet in that it is more convenient and comfortable to use hardware keys and mouse than onscreen keyboard to input formal text, and over a regular tablet with an attached hardware keyboard in that it is more convenient and comfortable to handwrite on the screen sitting flat on desk with the forearm resting on the desk than on the screen standing with some angle to the horizontal level.

16. Said new keyboard (44) of claims 13, 14, wherein said hardware keys (2), mouse (10) and mouse pad (3) can work with a PC (14) or a laptop (11) as a PC or a laptop with the advantage of additional way for handwriting or drawing input from said onscreen touch screen (7) over a traditional PC or a traditional laptop.

17. Said new keyboard (44) of claims 13, 14, 15, and 16 can work with a PC (14)/a laptop (11) as a PC/laptop and a tablet when two different software application are opened on regular screen (9) or (12) and touch screen (6) simultaneously so the user can wok more productively for the tablet efficient document and PC efficient document in one computer at the same time.

18. Said new keyboard (44) of claims 13, 14, 15, 16, can provide the best user experience when the same software application is opened and displayed on the regular screen (9) or (12) and touch screen (6) simultaneously in that the user can input contents to software application opened on the regular screen (9) or (12) by hardware keys (2) or mouse (10) and handwrite or draw directly on the touch screen (6) with pen (40) or eraser (41) kind of icons embedded on the user interface of software application, but the operating system needs to synchronize the output and input for the software application on said two screens with the input data being displayed on both screen before next input.

19. Said new keyboard (1) of claim 1 and new keyboard (44) of claim 13, wherein said small size touch screen (4) or large size touch screen (6) can be designed as a slidable screen that is attached to the bottom of the hardware keyboard, which makes the keyboard more convenient to be carried and more comfortable for handwriting with the forearm resting on the desk.

20. Said new keyboard (1) of claims 1, 19 and new keyboard (44) of claims 13, 19, wherein said slidable touch screen with either large or small size can be designed with a trigger power switch so the power for said slidable touch screen is turned on when it is pulled out and turned off when it is pushed in.

21. Said new keyboard (44) of claims 13, 14, 15, 16, 17, 18, 19, 20, wherein the touch screen (6) or (8) can be designed as independent of the hardware keys (2) and its connection with a PC (14), so the new keyboard (44) is compatible with the traditional PC that does not support the new keyboard (44).

22. Said new keyboard (1) of claims 1, 19, 20 and new keyboard (44) of claims 13, 19, 20, 21 wherein an optional fingerprint sensor (5) and its driver software can provide fingerprint for security login, replacing signature for document or identity verification.

23. Said new keyboard (1) of claims 1, 2, 3, 4, 5, 6, 7, 8, 9, 10, 11, 12, 19, 20, 22 and new keyboard (44) of claims 13, 14, 15, 16, 17, 18, 19, 20, 21, 22 wherein multiple pen icons (40) that will provide different style of point, line or curve, and multiple eraser icons (41) that will provide different size of square, can be displayed in the user interfaces (7) (8) (9) (10) (11) (12) (13) on said touch screen (4), or at user interfaces of software application on large size touch screen (6) or (8).

24. Said new keyboard (1) of claims 1, 2, 3, 4, 5, 6, 7, 8, 9, 10, 11, 12, 19, 20, 22, 23, and new keyboard (44) of claims 13, 14, 15, 16 17, 18, 19, 20, 21, 22, 23, wherein all user interfaces for touch screen (4) or (6) or (8) are designed without pen icon (40) so the user can handwrite or draw on the touch screen with a digital pen or a finger without the extra step to press the pen icon (40), but erasing kind of operation needs to press the erase icon (41) one more time to make the touch screen ready for writing and drawing after the erasing work is finished.

25. Said new keyboard (1) of claims 1, 2, 3, 4, 5, 6, 7, 8, 9, 10, 11, 12, 19, 20, 22, 23, 24 and new keyboard (44) of claims 13, 14, 15, 16, 17, 18, 19, 20, 21, 22, 23, 24, needs operating system, GPU and other components to support multiple input and multiple displays with shared memory, message queue, new system APIs, etc., and needs image kind of software application so user can output contents to any location of the software user interface at the cursor point last clicked, which maps to the coordinator origin on the touch screen, being the reference coordinator of the new input, whether the input is from the hardware keys (2) or handwrite or draw.
